(19) United States
(12) Patent Application Publication
(10) Pub. No.: US 2005/0214194 A1
(43) Pub. Date: Sep. 29, 2005

(54) Biological process for the preparation of mineral crystals using seeds

(76) Inventors: Absar Ahmad, Maharashtra (IN); Debabrata Rautaray, Maharashtra (IN); Ambarish Sanyal, Maharashtra (IN); Murali Sastry, Maharashtra (IN)

Correspondence Address: CHRISTIE, PARKER & HALE, LLP, PO BOX 7068, PASADENA, CA, 91109-7068, US

(21) Appl. No.: 10/807,992

(22) Filed: Mar. 23, 2004

(51) Int. Cl. C01F 11/18

(52) U.S. Cl. 423/430

(57) ABSTRACT

This invention relates to a biological process for the preparation of shape and polymorph controlled mineral crystals by simple growth of roots from various seeds to a suitable aqueous metal ion.

### CROSS-REFERENCE TO RELATED APPLICATION

This application claims the priority of International Application No. PCT/IB2003/006194, filed Dec. 27, 2003, the contents of which are incorporated herein by reference.

### FIELD OF THE INVENTION

This invention relates to a biological process for the preparation of mineral crystals using seeds. More particularly it relates to the preparation of size, shape and polymorph controlled mineral crystals by simple growth of roots from various seeds in a suitable aqueous solution of a metal ion. Still more it relates to a biological process for the preparation of mineral crystals by the reaction of suitable electrolyte solution with carbon dioxide generated during the root growth from the seed. Still it relates to a biological process for the synthesis controlled mineral crystals by the proteins secreted during the root growth from the seeds that are responsible for the size, shape and polymorph control of desired mineral crystals. It relates to a method for producing shape, size and polymorph controlled mineral crystals such as in the case of calcium carbonate (CaCO₃) where spherical vaterite crystals (most unstable polymorph of (CaCO₃) were obtained at room temperature, strontium carbonate (SrCO₃), barium carbonate (BaCO₃) by the natural growth of roots from the seeds. Shape control as well as polymorph control of minerals crystals can be obtained by using root growth from different seeds. The shape controlled particles formed by this process can be used in numerous technological and medical applications, e.g., as advanced ceramics, catalysts, filler materials, sensors, semiconductors, pigments, can be used in plastic industries, paper industries and many others.

### BACKGROUND AND PRIOR ART

Biological and materials synthesis and transformation are one of the core industries of world economy. Various techniques have been developed for large-scale generation of inorganic materials of controllable structure and size, some based on physical and some on chemical principles. Numerous substances are synthesized using processes that require non-ambient temperatures and/or non-ambient pressures that require capital-intensive equipment. Methods that can produce useful chemicals and materials at conditions closer to ambient conditions and use simple equipments are economically, ecologically and environmentally more desirable.

Significant research efforts have been devoted for nanostructure processing as a means to achieve materials having commercial requirements in areas as diverse as electronics, pigments, cosmetics, ceramics and medical industries, (Mann et al., Nature., 1996, 382, 313).

Langmuir monolayers have been shown to induce oriented crystallization from solution of proteins (Uzgiris and Kornberg et al Nature., 1983, 301, 125; Ahlers et al Thin Solid Films., 1989, 180, 93) and other organic and inorganic compounds (Landau et al Nature., 1985, 318, 353). Mann and co-workers have studied the oriented crystallization of CaCO₃ under monolayers of stearic acid (Mann et al, Nature., 1988, 334, 692; Mann et al Nature., 1988, 332, 119).

In biomimetic template such as self assembled monolayers (SAMs), Aizenberg, Black and Whitesides have shown that orientational match between carboxylate ions in SAMs and carbonate ions in the calcite nucleating phase is more important (Aigenberg et al, J. Am. Chem. Soc. 1999, 121, 4500). This often leads to the oriented growth of CaCO₃ crystals on surfaces such as terminally functionalized SAMs supported on metal films. (Kuther et al Chem. Eur. J. 1998, 4, 1834; Aigenberg et al, J. Am. Chem. Soc. 1999, 121, 4500). Travaille et al. have shown interesting hexagonal organization of highly oriented calcite crystals on Au (111) films covered by a monolayer of 16-mercaptohexadecanoic acid (Travaille et al Adv. Mater. 2002, 14, 492). Donners et al. have demonstrated the use of a shape persistent polymeric crystallization template [poly(L-isocyanoalanyl-D-alanine)] in the growth of calcite wherein crystal growth was influenced both by nucleation and adsorption processes (Donners et al J. Am. Chem. Soc. 2002, 124, 9700).

U.S. Pat. No. 6,325,987 provides a method for production of minerals in which uniformly sized and shaped particles of metal salts are provided comprised of one or more metal cations in combination with one or more simple oxoacid anions and a general method for the controlled precipitation of said metal salts from aqueous solutions.

U.S. Pat. No. 6,383,282 provides a method of pseudophasic extraction method for the separation of minerals which is a aqueous-based extraction method for the separation and recovery of ultra-fine mineral particles. The process operates within the pseudo phase region of the conventional aqueous biphasic extraction system where a low-molecular-weight, water soluble polymer alone is used in combination with a salt and operates within the pseudo-biphase regime of the conventional aqueous biphasic extraction system.

U.S. Pat. No. 6,416,682 provides a method of producing synthetic crystals (typically minerals) or comparable inorganic compounds by reactions of metal salts and metal oxyhydroxides under near-critical, critical or supercritical solvent conditions.

U.S. Pat. No. 6,568,537 provides a method for the flotation of useful minerals, comprising a frother based on dimethyl(isopropenylethynyl)carbinol and a collector, the frother, for improving the technological flotation characteristics, having the following chemical composition, in wt. %: dimethyl(isopropenylethynyl)carbinol, 95.0-98.0; tetramethylbutynediol, 0.1-1.5; diisopropenylacetylene, 0.1-1.0; 2,5-dimethyl-1,4-hexadien-3-one, 1.5-2.5.

All publications and patents mentioned in the above specification are herein incorporated by references. While in the foregoing specification, this invention has been described in relation to certain preferred embodiments thereof and many details have been set forth for purpose of illustration, it will be apparent to those skilled in the art that the invention is susceptible to additional embodiments and that certain of the details described herein can be varied considerably without departing from the basic principles of the invention.

### OBJECT OF THE INVENTION

The main object of the invention is to provide a biological process for the preparation of mineral crystals, which are user friendly.

It is another object of the invention to provide a process for the preparation of shape, size and polymorph controlled mineral crystals that are environmental friendly.

It is yet another object of the invention to provide an economic and efficient process for the preparation of shape, size and polymorph controlled mineral crystals. These and other objects of the invention are achieved by the process of the invention, which uses a biological method for the preparation of shape, size and polymorph controlled mineral crystals.

### SUMMARY OF THE INVENTION

The present invention provides a biological process for the preparation of mineral crystals, which comprises growing of roots from surface sterilized seeds to an aqueous metal salt solution at a temperature in the range of 20 to 35° C. for 1 to 5 days to obtain the respective mineral crystals of respective metal carbonates.

### DESCRIPTION OF THE INVENTION

Accordingly, the invention relates to a biological process for the preparation of shape and polymorph controlled mineral crystals by simple growth of roots from various seeds to a suitable aqueous metal ion. More particularly it relates to a biological process for the preparation of mineral crystals by the reaction of suitable electrolyte solution with carbon dioxide generated during the root growth from the seed. Still it relates to a biological process for the synthesis mineral crystals controlled by the proteins secreted during the root growth from the seeds that are responsible for the size, shape and polymorph control of desired mineral crystals. More particularly it relates to a method for producing shape, size and polymorph controlled mineral crystals such as calcium carbonate (CaCO₃), strontium carbonate (SrCO₃), barium carbonate (BaCO₃) by the natural growth of roots from the seeds. Shape control as well as polymorph control of minerals crystals can be obtained by using root growth from different seeds.

In one of the embodiment of the present invention, the process provides a biological process for the preparation of mineral crystals, which comprises growing of roots from surface sterilized seeds to an aqueous metal salt solution at a temperature in the range of 20 to 35° C. for 1 to 5 days to obtain the respective mineral crystals of respective metal carbonates.

Of the embodiments of the present invention, the seeds used are Cicer arietinum, Pisum sativum, Lycopersicon esculentum, Oryza sativa, Triticum aestivum, Coriandrum sativum, Papaver somniferum, Ocimum basilicum, Trigonella foenum-graecum, Vigna radiata, Zea mays, Hordeum vulgare, Brassica campestris, Vigna mungo, Vigna unguiculata, Ricinus communis, Solanum melongena, Paspalum scrobiculatum, Raphanus sativus, Gossypium herbaceum, Helianthus annus, Linum usitatissinum, Luffa cylindrica, Cucumis sativus, Cymbopogon flexuosus, Daucus carota, Abelmoschus esculentus, Anethum graveolens, Cajanus cajan, Capsicum annuum, Carica papaya, Datura innoxia, Catharanthus roseus, Spinacia oleracea, Citrullus vulgaris.

In another embodiment of the invention, the reaction of the CO₂ generated during root growth and the suitable electrolyte solution is carried out in water.

The process of the invention is described herein below with reference to the following examples, which are illustrative and should not be construed as limiting the scope of the invention.

### BRIEF DESCRIPTION OF THE TABLE

Table 1: XRD pattern of polymorph of CaCO₃

### EXAMPLES

### Example 1

This example illustrates the preparation of CaCO₃ crystals by using the seeds of chick pea (Cicer arietinum). The seeds were washed with sterile distilled water and then soaked for 45 min. in water. After soaking, seeds were surface sterilized with Na-hypochlorite solution for 3 mins, then washed well with sterile distilled water and spread on moistened Whatman filter paper in autoclaved Petridish (250 mm diameter). Closed Petridish was placed in the dark, at 25-26° C., for 3 days for germination. The germinated seeds were placed on moistened filter paper support in autoclaved Erlenmeyer flask containing 100 ml sterile 10⁻² M aqueous CaCl₂ solution for 5 to 10 days. The Erlenmeyer flask was then plugged with cotton and incubated 25-26° C. The bio-transformation was routinely monitored by periodic sampling of aliquots (10 ml) under sterile conditions for analysis. The sample was characterized by X-ray diffraction (XRD) measurement. The XRD results shown in table below obtained correspond to that of variety polymorph of CaCO₃.

TABLE 1

| Interplanar distance d (A°) | Intensity | hkl(planes) |
|---|---|---|
| 3.294 | 100 | 112 |
| 2.73 | 90 | 114 |
| 2.318 | 5 | 211 |
| 2.113 | 20 | 008 |
| 2.063 | 60 | 300 |

### Example 2

This example illustrates the preparation of CaCO₃ crystals by using the seeds of Vigna radiata seeds were washed with sterile distilled water and then soaked for 45 min. in water. After soaking, seeds were surface sterilized with Na-hypochlorite solution for 3 mins, then washed well with sterile distilled water and spread on moistened Whatman filter paper in autoclaved Petridish (250 mm diameter). Closed Petridish was placed in the dark, at 25-26° C., for 3 days for germination. The germinated seeds were placed on moistened filter paper support in autoclaved Erlenmeyer flask containing 100 ml sterile 10⁻² M aqueous CaCl₂ solution for 5 to 10 days. The Erlenmeyer flask was then plugged with cotton and incubated 25-26° C. The bio transformation was routinely monitored by periodic sampling of aliquots (10 ml) under sterile conditions for analysis.

### Example 3

This example illustrates the preparation of CaCO₃ crystals by using the seeds of Pisum satium seeds were washed with sterile distilled water and then soaked for 45 min. in water. After soaking, seeds were surface sterilized with Na-hypochlorite solution for 3 mins, then washed well with sterile distilled water and spread on moistened Whatman filter paper in autoclaved Petridish (250 mm diameter). Closed Petridish was placed in the dark, at 25-26° C., for 3 days for germination. The germinated seeds were placed on moistened filter paper support in autoclaved Erlenmeyer flask containing 100 ml sterile 10⁻² M aqueous CaCl₂ solution for 5 to 10 days. The Erlenmeyer flask was then plugged with cotton and incubated 25-26° C. The bio transformation was routinely monitored by periodic sampling of aliquots (10 ml) under sterile conditions for analysis.

### Example 4

This example illustrates the preparation of SrCO₃ crystals by using the seeds of Chick pea (Cicer arietinum) seeds were washed with sterile distilled water and then soaked for 45 min. in water. After soaking, seeds were surface sterilized with Na-hypochlorite solution for 3 mins, then washed well with sterile distilled water and spread on moistened Whatman filter paper in autoclaved Petridish (250 mm diameter). Closed Petridish was placed in the dark, at 25-26° C., for 3 days for germination. The germinated seeds were placed on moistened filter paper support in autoclaved Erlenmeyer flask containing 100 ml sterile 10⁻³ M aqueous SrCl₂ solution for 5 to 10 days. The Erlenmeyer flask was then plugged with cotton and incubated 25-26° C. The bio transformation was routinely monitored by periodic sampling of aliquots (10 ml) under sterile conditions for analysis.

### Example 5

This example illustrates the preparation of BaCO₃ crystals by using the seeds of Chick pea (Cicer arietinum) seeds were washed with sterile distilled water and then soaked for 45 min. in water. After soaking, seeds were surface sterilized with Na-hypochlorite solution for 3 mins, then washed well with sterile distilled water and spread on moistened Whatman filter paper in autoclaved Petridish (250 mm diameter). Closed Petridish was placed in the dark, at 25-26° C., for 3 days for germination. The germinated seeds were placed on moistened filter paper support in autoclaved Erlenmeyer flask containing 100 ml sterile 10⁻³ M aqueous BaCl₂ solution for 5 to 10 days. The Erlenmeyer flask was then plugged with cotton and incubated 25-26° C. The bio transformation was routinely monitored by periodic sampling of aliquots (10 ml) under sterile conditions for analysis.

Advantages of the process claimed in the present invention are:

1. The main advantage of the present invention is the use of natural growth of seeds under aqueous medium.
2. Another major advantage of the present invention is that the mineral crystals formed are quite stable in the aqueous solution.
3. Another advantage of the present invention is that the mineral crystals formed are of highly controlled in shape.
4. Another major advantage of the present invention is that different polymorphism of the suitable mineral can be achieved by using suitable seeds.
5. Uniform size control
6. Large scale synthesis is possible
7. Ambient experimental conditions
8. Cost effective/Economical system for the industry
9. High stability of the particles formed
10. The method of the invention is also environmentally friendly and simple.

1. A process for the preparation of mineral crystals, the process comprising germinating seeds and growing the roots thus germinated in an aqueous solution containing one or more metal salts at a temperature in the range of 20 to 35° C. for a period of 2 to 7 days to obtain the mineral crystals of respective metal carbonates.

2. The process as claimed in claim 1, wherein in the seeds used are selected from a group consisting of Cicer arietinum, Pisum sativum, Lycopersicon esculentum, Oryza sativa, Triticum aestivum, Coriandrum sativum, Papaver somniferum, Ocimum basilicum, Trigonella foenum-graecum, Vigna radiata, Zea mays, Hordeum vulgare, Brassica campestris, Vigna mungo, Vigna unguiculata, Ricinus communis, Solanum melongena, Paspalum scrobiculatum, Raphanus sativus, Gossypium herbaceum, Helianthus annus, Linum usitatissinum, Luffa cylindrica, Cucumis sativus, Cymbopogon flexuosus, Daucus carota, Abelmoschus esculentus, Anethum graveolens, Cajanus cajan, Capsicum annuum, Carica papaya, Datura innoxia, Catharanthus roseus, Spinacia oleracea and Citrullus vulgaris.

3. The process as claimed in claim 1, wherein the seeds are washed and sterilized prior to germination.

4. The process as claimed in claim 3, wherein the seeds are sterilized using sodium hypochlorite solution.

5. The process as claimed in claim 4, wherein the seeds are sterilized by treating the same with sodium hypochlorite solution for a time period in the range of 2-4 minutes.

6. The process as claimed in claim 1, wherein the seeds are germinated in a dark room at a temperature in the range of 20 to 30° C. for a time period in the range of 2 to 5 days.

7. The process as claimed in claim 1, wherein the metal salt used is selected from the group consisting of salts of Ca²⁺, Sr²⁺, and Ba²⁺, and mixtures thereof.

8. The process as claimed in claim 7, wherein the metal salts used are selected from a group comprising CaCO₃, SrCO₃, BaCO₃ and their mixtures thereof.

9. The process as claimed in claim 8, wherein the concentration of metal ions in the aqueous solution is in the range of about 0.001 to about 1 M.

10. The process as claimed in claim 1, wherein the crystal formed are obtained by filtration and drying.
